(19) United States
(12) Patent Application Publication
(10) Pub. No.: US 2011/0102069 A1
(43) Pub. Date: May 5, 2011

(54) CHARGE PUMP CIRCUIT AND DRIVING METHOD THEREOF

(76) Inventors: Tzung-Shing Tsai, Taipei County (TW); Yao-Ching Wang, Chang-Hua Hsien (TW)

(21) Appl. No.: 12/869,769

(22) Filed: Aug. 27, 2010

(30) Foreign Application Priority Data
Nov. 3, 2009 (TW) 098137233

(51) Int. Cl. G05F 3/02

(52) U.S. Cl. 327/536

(57) ABSTRACT

A charge pump circuit includes an input end, a first reservoir capacitor, a second reservoir capacitor, two output ends, a charge pump unit and a charge module. The input end receives an input voltage, and the two output ends output a positive pumping voltage and a negative pumping voltage, respectively. The charge pump unit is utilized for charging the first reservoir capacitor and the second reservoir capacitor respectively by referring to a plurality of operational phases, wherein the charge pump unit does not charge at least one designated reservoir capacitor of the first reservoir capacitor and the second reservoir capacitor during at least one designated operational phase of the plurality of operational phases. When the charge pump unit operates in the at least one designated operational phase, the charge module is utilized for charging the at least one designated reservoir capacitor.

### BACKGROUND OF THE INVENTION

1. Field of the Invention

The present invention relates to a charge pump circuit, and more particularly, to a charge pump circuit having a charge module with built-in capacitors and a related driving method.

2. Description of the Prior Art

Charge pump circuits are typically applied in driving circuits of electronic products, such as memory drivers, LCD backlight modules, and LED backlight drivers. The charge pump circuit accomplishes energy transfer and voltage conversion by using charges stored on capacitors to establish required positive output voltages (e.g., its pumping factor is equal to 2) or negative output voltages (e.g., its pumping factor is equal to (−1)), and also simultaneously provides different output voltages at various voltage levels.

Please refer to FIG. 1. FIG. 1 is a diagram showing a conventional charge pump circuit 100 according to the prior art. The conventional charge pump circuit 100 includes a charge pump unit 102, a flying capacitor CF1, a first reservoir capacitor CR1, and a second reservoir capacitor CR2. The charge pump unit 102 performs charging and discharging operations upon the flying capacitor CF1, the first reservoir capacitor CR1 as well as the second reservoir capacitor CR2 by referring to a charge pump clock (not shown), such that an input voltage VCI can be converted into the desired positive pumping voltage DDVDH and the negative pumping voltage VCL. Herein the positive pumping voltage DDVDH is mostly a positive multiple of the voltage level of the input voltage VCI, while the negative pumping voltage VCI is mostly a negative multiple of the input voltage VCI.

However, in practice, the conventional charge pump circuit 100 needs to achieve high pumping efficiency, so that more external capacitors for energy storage and transfer are required in the conventional charge pump circuit 100. As an illustration, the charge pump circuit 100 utilizes three external capacitors (first reservoir capacitor CR1, the second reservoir capacitor CR2, and the flying capacitor CF1). Therefore, too many external capacitors may waste manufacturing cost. Hence, how to reduce the amount of the external capacitors and give consideration to the pumping efficiency of the charge pump circuit have become an important topic of this filed.

### SUMMARY OF THE INVENTION

It is one of the objectives of the claimed invention to provide a charge pump circuit having a charge module with built-in capacitors and a related driving method to solve the abovementioned problems.

According to one embodiment, a charge pump circuit for outputting a positive pumping voltage and a negative pumping voltage according to an input voltage is provided. The charge pump circuit includes an input end, a first reservoir capacitor, a second reservoir capacitor, a first output end, a second output end, a charge pump unit, and a charge module. The input end is utilized for receiving the input voltage. The first output end is coupled to the first reservoir capacitor, for outputting the positive pumping voltage. The second output end is coupled to the second reservoir capacitor, for outputting the negative pumping voltage. The charge pump unit is coupled to the input end, the first reservoir capacitor, the second reservoir capacitor, and a reference voltage, for charging the first reservoir capacitor and the second reservoir capacitor respectively by referring to a plurality of operational phases, wherein the charge pump unit does not charge at least one designated reservoir capacitor of the first reservoir capacitor and the second reservoir capacitor during at least one designated operational phase of the plurality of operational phases. The charge module is coupled to the charge pump unit, the input end, and the reference voltage, for charging the at least one designated reservoir capacitor when the charge pump unit operates in the at least one designated operational phase.

According to another embodiment, a driving method applied to a charge pump circuit is provided, which drives the charge pump circuit to output a positive pumping voltage and a negative pumping voltage according to an input voltage, the charge pump circuit comprising a charge pump unit and a charge module. The method includes the steps of: receiving the input voltage; making use of the charge pump unit for charging the first reservoir capacitor and the second reservoir capacitor respectively by referring to a plurality of operational phases, wherein the charge pump unit does not charge at least one designated reservoir capacitor of the first reservoir capacitor and the second reservoir capacitor during at least one designated operational phase of the plurality of operational phases; making use of the charge module for charging the at least one designated reservoir capacitor when the charge pump unit operates in the at least one designated operational phase; and outputting the positive pumping voltage via the first reservoir capacitor, and outputting the negative pumping voltage via the second reservoir capacitor.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a diagram showing a conventional charge pump circuit according to the prior art.

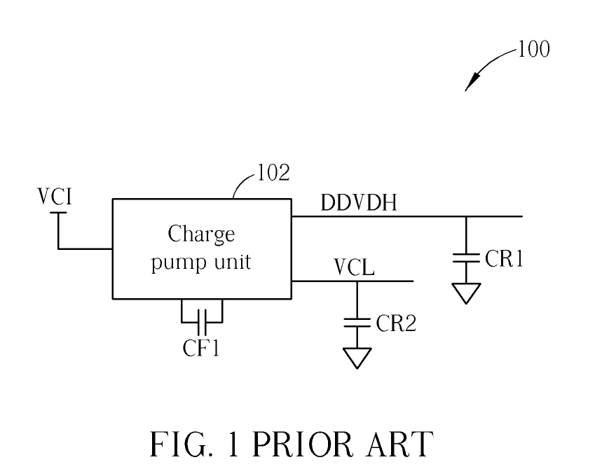

FIG. 2 is a diagram showing a charge pump circuit according to a first embodiment of the present invention.

FIG. 3 is a diagram illustrating the operational phases of the charge pump circuit shown in FIG. 2.

FIG. 4 is a flowchart illustrating a driving method that drives a charge pump circuit to output a positive pumping voltage and a negative pumping voltage based on an input voltage according to an exemplary embodiment of the present invention.

FIG. 5 is a diagram showing a charge pump circuit according to a second embodiment of the present invention.

FIG. 6 is a diagram showing a charge pump circuit according to a third embodiment of the present invention.

### DETAILED DESCRIPTION

Certain terms are used throughout the following description and claims to refer to particular components. As one skilled in the art will appreciate, hardware manufacturers may refer to a component by different names. This document does not intend to distinguish between components that differ in name but not in function. In the following discussion and in the claims, the terms “include”, “including”, “comprise”, and “comprising” are used in an open-ended fashion, and thus should be interpreted to mean “including, but not limited to . . . ”. The terms “couple” and “coupled” are intended to mean either an indirect or a direct electrical connection. Thus, if a first device couples to a second device, that connection may be through a direct electrical connection, or through an indirect electrical connection via other devices and connections.

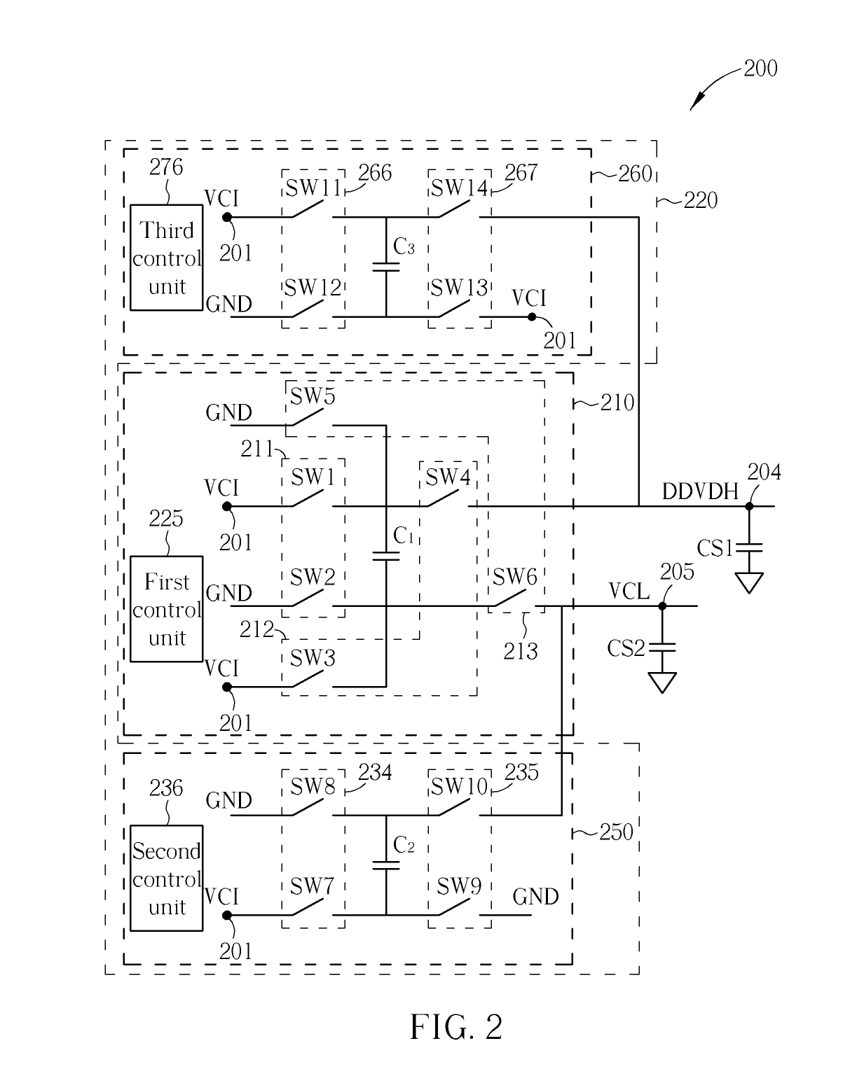

Please refer to FIG. 2. FIG. 2 is a diagram showing a charge pump circuit 200 according to a first embodiment of the present invention. The charge pump circuit 200 outputs a positive pumping voltage DDVDH and a negative pumping voltage VCL according to an input voltage VCI. In this embodiment, the charge pump circuit 200 includes, but is not limited to, an input end 201, a first reservoir capacitor CS1, a second reservoir capacitor CS2, a first output end 204, a second output end 205, a charge pump unit 210, and a charge module 220. The input end 201 is utilized for receiving the input voltage VCI; the first output end 204 is coupled to the first reservoir capacitor CS1 for outputting the positive pumping voltage DDVDH; and the second output end 205 is coupled to the second reservoir capacitor CS2 for outputting the negative pumping voltage VCL. In addition, the charge pump unit 210 is coupled to the input end 201, the first reservoir capacitor CS1, the second reservoir capacitor CS2, and a reference voltage. In this embodiment, a ground GND represents the reference voltage, but this is presented merely for illustration and should not be considered as limitations of the present invention. The charge pump unit 210 charges the first reservoir capacitor CS1 and the second reservoir capacitor CS2 respectively by referring to a plurality of operational phases (e.g., the operational phases PH1˜PH4 mentioned hereafter). The charge module 220 is coupled to the charge pump unit 210, the input end 201, and the reference voltage GND. What calls for special attention is that the charge pump unit 210 does not charge at least one designated reservoir capacitor of the first reservoir capacitor CS1 and the second reservoir capacitor CS2 during at least one designated operational phase of the plurality of operational phases; while the charge module 220 charges the at least one designated reservoir capacitor when the charge pump unit 210 operates in the at least one designated operational phase. Details will be further explained in the following embodiments.

As shown in FIG. 2, the charge pump unit 210 includes a first capacitor C1, a first switching module 211, a second switching module 212, a third switching module 213, and a first control unit 225. The first switching module 211 is coupled to the input end 201, the reference voltage GND, and the first capacitor C1, wherein the first switching module 211 has switches SW1 and SW2. The second switching module 212 is coupled to the input end 201, the reference voltage GND, the first capacitor C1, and the first output end 204, wherein the second switching module 212 has switches SW3 and SW4. The third switching module 213 is coupled to the input end 201, the reference voltage GND, the first capacitor C1, and the second output end 205, wherein the third switching module 213 has switches SW5 and SW6. As the connection relationship of the switches SW1˜SW6 has been already shown in FIG. 2, and further description is omitted here for brevity.

Furthermore, the first control unit 225 controls ON/OFF states of the first switching module 211, the second switching module 212, and the third switching module 213 in order to control the charge pump unit 210 to operate in the plurality of operational phases respectively. In this embodiment, the plurality of operational phases are implemented by a first operational phase PH1, a second operational phase PH2, a third operational phase PH3, as well as a fourth operational phase PH4, but this is presented merely for describing the present invention and in no way should be considered to be limitations of the present invention. Be noted that operating principles of the first operational phase PH1, the second operational phase PH2, the third operational phase PH3, as well as the fourth operational phase PH4 are detailed as below:

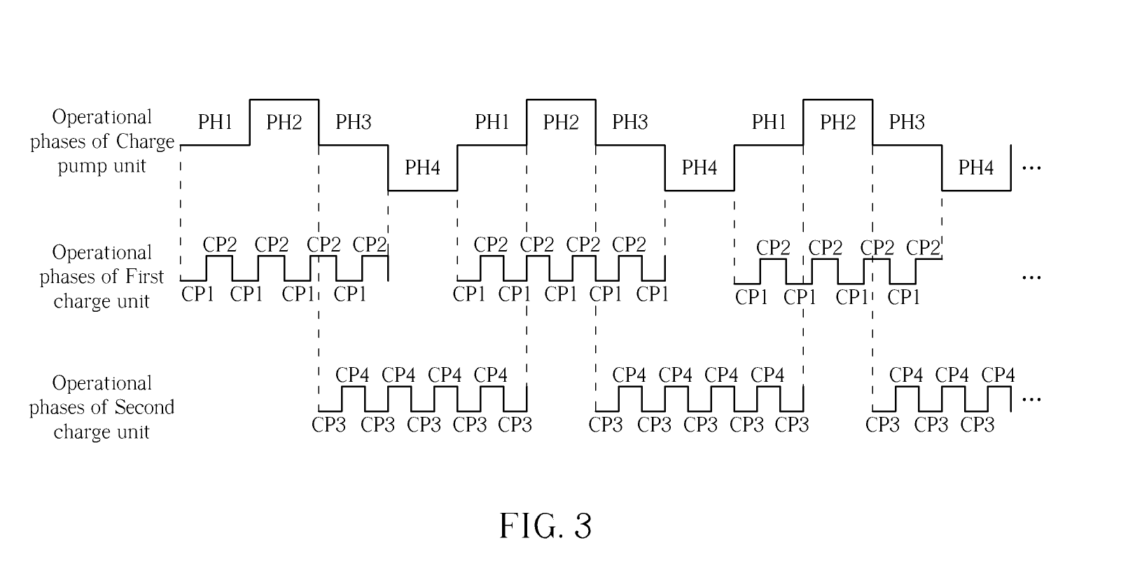

Please refer to FIG. 2 together with FIG. 3. FIG. 3 is a diagram illustrating the operational phases of the charge pump circuit 200 shown in FIG. 2. During the first operational phase PH1, the first control unit 225 controls the switches SW1 and SW2 to switch to an ON-state, and all the other switches maintain in an open state (i.e., an OFF-state). Under this first condition, the input voltage VCI charges the first capacitor C1, such that the voltage of the first capacitor C1 can reach to the voltage level of the input voltage VCI. During the second operational phase PH2, the first control unit 225 controls the switches SW3 and SW4 to switch to the ON-state, and all the other switches switch to the OFF-state. Under this second condition, the input voltage VCI and the first capacitor C1 charge the first reservoir capacitor CS1, such that the first reservoir capacitor CS1 will substantially reach to twice of the voltage level the input voltage VCI. During the third operational phase PH3, the first control unit 225 controls the switches SW1 and SW2 to switch to the ON-state again, and all the other switches maintain in the OFF-state. Under the third condition, the input voltage VCI charge the first capacitor C1, such that the first capacitor C1 can reach to the voltage level of the input voltage VCI. During the fourth operational phase PH4, the first control unit 225 controls the switches SW5 and SW6 to switch to the ON-state, and all the other switches maintain in the OFF-state. Under this fourth condition, the first capacitor C1 charges the second reservoir capacitor CS2, such that the second reservoir capacitor CS2 can reach to a negative multiple of the voltage level of the input voltage VCI. Be noted that the first control unit 225 switches the aforementioned four operational phases PH1˜PH4 according to a switching frequency. In doing so, a purpose of implementing the charge pump unit 210 so as to provide a multiple voltage (a positive voltage) or a negative voltage can be achieved.

The charge module 220 includes a first charge unit 250 and a second charge unit 260. The first charge unit 250 includes a second capacitor C2, a fourth switching module 234, a fifth switching module 235, and a second control unit 236. The fourth switching module 234 is coupled to the input end 201, the reference voltage GND, and the second capacitor C2, wherein the fourth switching module 234 has switches SW7 and SW8. The fifth switching module 235 is coupled to the reference voltage GND, the second capacitor C2, and the second output end 205, wherein the fifth switching module 234 has switches SW9 and SW10.

Moreover, the second control unit 236 controls ON/OFF states of the fourth switching module 234 and the fifth switching module 235. Be noted that when the charge pump unit 210 operates in the first operational phase PH1, the second operational phase PH2, or the third operational phase PH3, the second control unit 236 controls the first charge unit 250 to respectively operate in a first charge unit operational phase CP1 and a second charge unit operational phase CP2. During the first charge unit operational phase CP1, the second control unit 236 controls the switches SW7 and SW8 to switch to the ON-state, and the switches SW9 and SW10 maintain in the OFF-state. Under this condition, the input voltage VCI charges the second capacitor C2, such that the second capacitor C2 can reach to the voltage level of the input voltage VCI. During the second charge unit operational phase CP2, the second control unit 236 controls the switches SW9 and SW10 to switch to the ON-state, and the switches SW7 and SW8 maintain in the OFF-state. Under this condition, the second capacitor C2 charges the second reservoir capacitor CS2. That is, the charges stored in the second capacitor C2 are transferred to the second reservoir capacitor CS2, such that the second reservoir capacitor CS2 can reach to a negative multiple of the voltage level of the input voltage VCI.

On the other hand, the second charge unit 260 includes a third capacitor C3, a sixth switching module 266, a seventh switching module 267, and a third control unit 276. The sixth switching module 266 is coupled to the input end 201, the reference voltage GND, and the third capacitor C3, wherein the sixth switching module 266 has switches SW11 and SW12. The seventh switching module 267 is coupled to the input end 201, the third capacitor C3, and the first output end 204, wherein the seventh switching module 267 has switches SW13 and SW14. The third control unit 276 controls ON/OFF states of the sixth switching module 266 and the seventh switching module 267. When the charge pump unit 210 operates in the first operational phase PH1, the third operational phase PH3, or the fourth operational phase PH4, the third control unit 276 controls the second charge unit 260 to respectively operate in a third charge unit operational phase CP3 and a fourth charge unit operational phase CP4. During the third charge unit operational phase CP3, the third control unit 276 controls the switches SW11 and SW12 to switch to the ON-state, and the switches SW13 and SW14 maintain in the OFF-state. Under this condition, the input voltage VCI charges the third capacitor C3, such that the capacitor C3 can reach to the voltage level of the input voltage VCI. During the fourth charge unit operational phase CP4, the third control unit 276 controls the switches SW13 and SW14 to switch to the ON-state, and the switches SW11 and SW12 maintain in the OFF-state. Under this condition, the input voltage VCI and the third capacitor C3 charge the first reservoir capacitor CS1, such that the first reservoir capacitor CS1 can reach to twice of the voltage level of the input voltage VCI.

In short, in the first operational phase PH1, the second operational phase PH2 or the third operational phase PH3, the charge pump unit 210 does not charge the second reservoir capacitor CS2. As a result, the charge module 220 operates in the first charge unit operational phase CP1 as well as the second charge unit operational phase CP2 in order to charge the second reservoir capacitor CS2. Similarly, in the first operational phase PH1, the third operational phase PH3 or the fourth operational phase PH3, the charge pump unit 210 does not charge the first reservoir capacitor CS1. As a result, the charge module 220 operates in the third charge unit operational phase CP3 as well as the fourth charge unit operational phase CP4 in order to charge the first reservoir capacitor CS1.

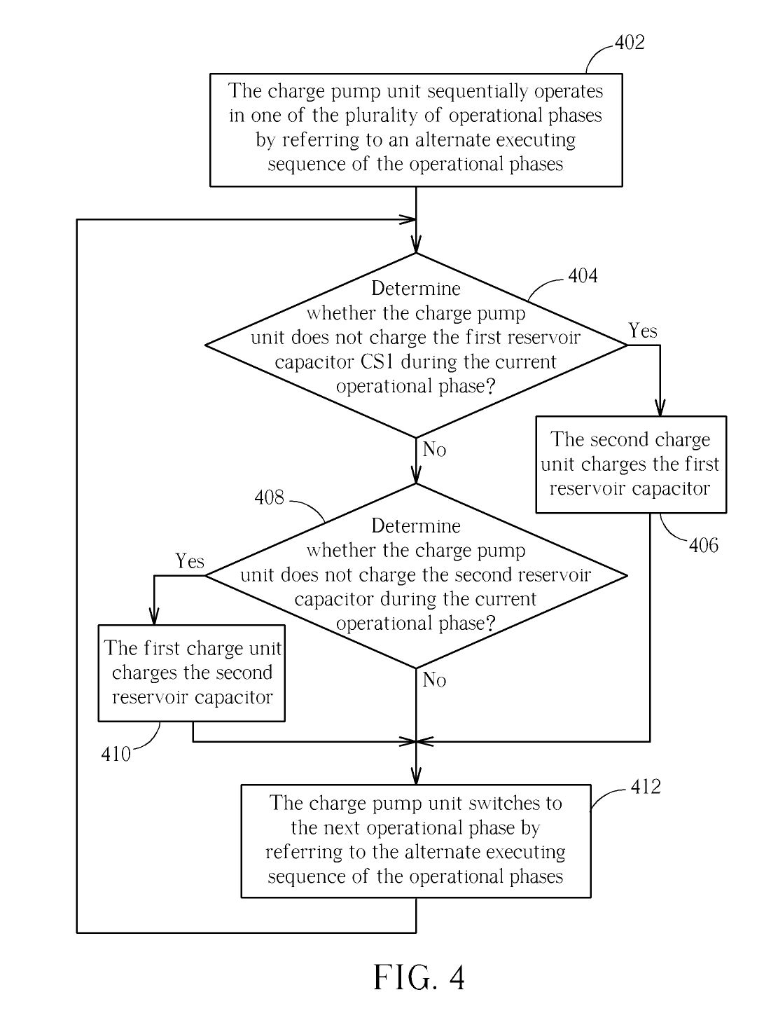

Please refer to FIG. 4. FIG. 4 is a flowchart illustrating a driving method that drives a charge pump circuit to output a positive pumping voltage DDVDH and a negative pumping voltage VCL based on an input voltage VCI according to an exemplary embodiment of the present invention. Please note that the following steps are not limited to be performed according to the exact sequence shown in FIG. 4 if a roughly identical result can be obtained. The method includes, but is not limited to, the following steps:

Step 402: The charge pump unit 210 sequentially operates in one of the plurality of operational phase (e.g., PH1, PH2, PH3 and PH4) by referring to an alternate executing sequence of the operational phases.

Step 404: Determine whether the charge pump unit 210 does not charge the first reservoir capacitor CS1 during the current operating phase of the charge pump unit 210. If yes, go to the Step 406; otherwise, go to the Step 408.

Step 406: The second charge unit 260 charges the first reservoir capacitor CS1. After that, go to the Step 412.

Step 408: Determine whether the charge pump unit 210 does not charge the second reservoir capacitor CS2 during the current operation phase of the charge pump unit 210. If yes, go to the Step 410; otherwise, go to the Step 412.

Step 410: The first charge unit 250 charges the second reservoir capacitor CS2.

Step 412: The charge pump unit 210 switches to the next operational phase by referring to the alternate executing sequence of the operational phases. After that, go to the Step 404.

As one skilled in the art will easily appreciate how each element operates by collocating the steps shown in FIG. 4 together with the elements shown in FIG. 2 and the operational phases shown in FIG. 3, and further description of the steps shown in FIG. 4 is omitted here for brevity. Please note that, the steps of the abovementioned flowchart are merely practicable embodiments of the present invention, and in no way should be considered to be limitations of the scope of the present invention. Those skilled in the art should observe that the method shown in FIG. 4 can include other intermediate steps or several steps can be merged into a single step without departing from the spirit of the present invention.

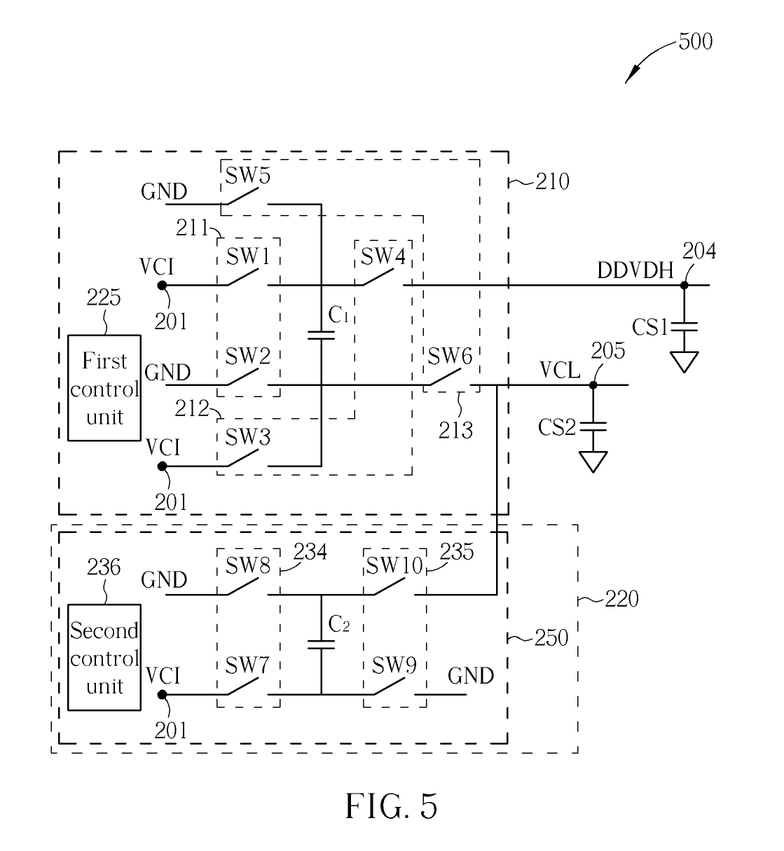

Please refer to FIG. 5. FIG. 5 is a diagram showing a charge pump circuit 500 according to a second embodiment of the present invention. The architecture of the charge pump circuit 500 is similar to that of the charge pump circuit 200 shown in FIG. 2, and the difference between them is that the charge pump circuit 500 omits the second charge unit 260 included by the charge pump circuit 200. For this reason, as for the charge pump circuit 500, since the charge pump unit 210 does not charge the second reservoir capacitor CS2 during the first operational phase PH1, the second operational phase PH2, or the third operational phase PH3, the first charge unit 250 will operate in the first charge unit operational phase CP1 and the second charge unit operational phase CP2 in order to charge the second reservoir capacitor CS2. The operating principles of the charge pump circuit 500 are similar to that of the charge pump circuit 200 shown in FIG. 2, and thus those skilled in the art should appreciate it easily based on the descriptions for the charge pump circuit 200 mentioned above. Therefore, detailed description is omitted here.

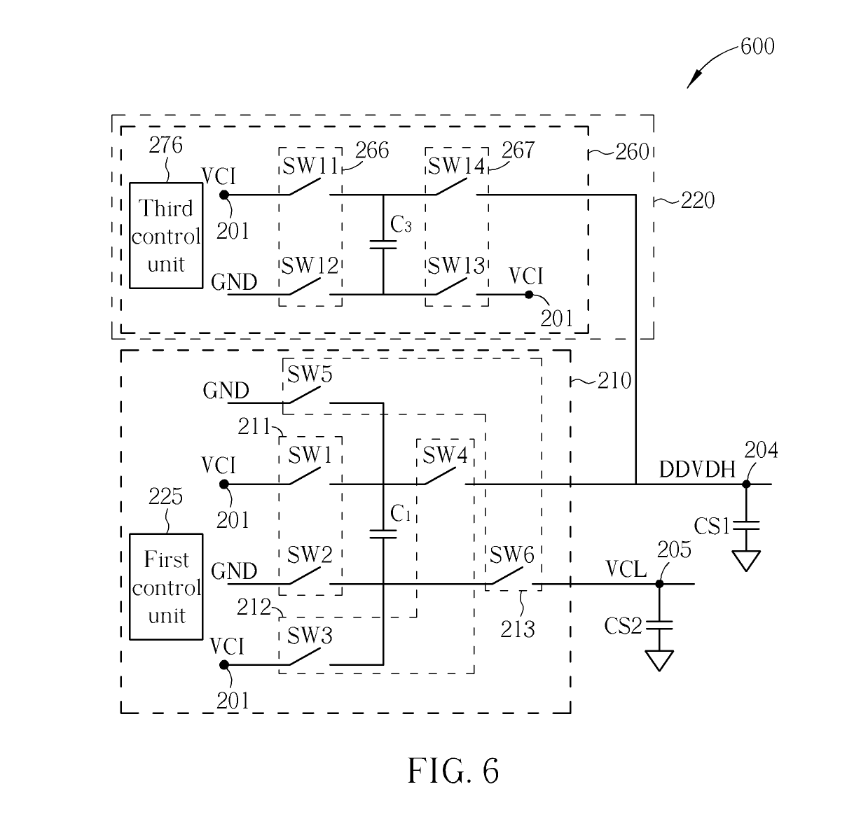

Please refer to FIG. 6. FIG. 6 is a diagram showing a charge pump circuit 600 according to a third embodiment of the present invention. The architecture of the charge pump circuit 600 is similar to that of the charge pump circuit 200 shown in FIG. 2, and the difference between them is that the charge pump circuit 600 omits the first charge unit 250 included by the charge pump circuit 200. For this reason, as for the charge pump circuit 600, since the charge pump unit 210 does not charge the first reservoir capacitor CS1 during the first operational phase PH1, the second operational phase PH2, or the fourth operational phase PH4, the second charge unit 260 will operate in the third charge unit operational phase CP3 and the fourth charge unit operational phase CP4 in order to charge the first reservoir capacitor CS1. The operating principles of the charge pump circuit 500 are similar to that of the charge pump circuit 200 shown in FIG. 2, and thus those skilled in the art should appreciate it easily based on the descriptions for the charge pump circuit 200 mentioned above. Therefore, detailed description is omitted here.

Be noted that in the abovementioned embodiments, the second capacitor C2, the third capacitor C3, as well as the second reservoir capacitor CS2 are implemented by built-in capacitors. In other words, the second reservoir capacitor CS2, the charge module 220, the first switching module 211, the second switching module 212, the third switching module 213, the second capacitor C2, the fourth switching module 234, the fifth switching module 235, the third capacitor C3, the sixth switching module 266, as well as the seventh switching module 267 are disposed in an identical chip; and the first reservoir capacitor CS1 as well as the first capacitor C1 are externally connected to the chip. However, this is merely a practicable embodiment of the present invention, and is not meant to be limitations of the present invention. In other embodiments, the second capacitor C2, the third capacitor C3 or the second reservoir capacitor CS2 can be externally connected to the chip, which also belongs to the scope of the present invention.

Moreover, in the embodiments above, both a switching frequency between the first charge unit operational phase CP1 and the second charge unit operational phase CP2 of the first charge unit 250 and a switching frequency between the third charge unit operational phase CP3 and the fourth charge unit operational phase CP4 of the second charge unit 260 are higher than a switching frequency between the first operational phase PH1, the second operational phase PH2, the third operational phase PH3, and the fourth operational phase PH4 of the charge pump unit 210, as is also shown in FIG. 3. Therefore, the pumping efficiency of the charge pump circuit can be substantially improved.

As can be known, the present invention provides a charge pump circuit having a charge module with built-in capacitors, such that the pumping efficiency of the charge pump circuit can be improved. When the charge pump unit does not charge at least one designated reservoir capacitor of the first reservoir capacitor CS1 and the second reservoir capacitor CS2, the charge module charges the designated reservoir capacitor by referring to the charge unit operational phases with a higher switching frequency in order to improved the pumping efficiency of the charge pump circuit. Especially when the reservoir capacitors are implemented by replacing external capacitors with built-in capacitors, the charge module is required in order to improve the pumping efficiency of the charge pump circuit.

Those skilled in the art will readily observe that numerous modifications and alterations of the device and method may be made while retaining the teachings of the invention.

What is claimed is:

1. A charge pump circuit for outputting a positive pumping voltage and a negative pumping voltage according to an input voltage, the charge pump circuit comprising:
an input end, for receiving the input voltage;
a first reservoir capacitor;
a second reservoir capacitor;
a first output end, coupled to the first reservoir capacitor, for outputting the positive pumping voltage;
a second output end, coupled to the second reservoir capacitor, for outputting the negative pumping voltage;
a charge pump unit, coupled to the input end, the first reservoir capacitor, the second reservoir capacitor, and a reference voltage, for charging the first reservoir capacitor and the second reservoir capacitor respectively by referring to a plurality of operational phases, wherein the charge pump unit does not charge at least one designated reservoir capacitor of the first reservoir capacitor and the second reservoir capacitor during at least one designated operational phase of the plurality of operational phases; and
a charge module, coupled to the charge pump unit, the input end, and the reference voltage, for charging the at least one designated reservoir capacitor when the charge pump unit operates in the at least one designated operational phase.

2. The charge pump circuit of claim 1, wherein the at least one designated reservoir capacitor comprises the first reservoir capacitor.

3. The charge pump circuit of claim 2, wherein the at least one designated reservoir capacitor further comprises the second reservoir capacitor.

4. The charge pump circuit of claim 1, wherein the at least one designated reservoir capacitor comprises the second reservoir capacitor.

5. The charge pump circuit of claim 1, wherein the plurality of operational phases sequentially comprise a first operational phase, a second operational phase, a third operational phase, and a fourth operational phase, and the charge pump unit comprises:
a first capacitor;
a first switching module, coupled to the input end, the reference voltage, and the first capacitor;
a second switching module, coupled to the input end, the reference voltage, the first capacitor, and the first output end;
a third switching module, coupled to the input end, the reference voltage, the first capacitor, and the second output end; and
a first control unit, for controlling ON/OFF states of the first switching module, the second switching module, and the third switching module in order to control the charge pump unit to operate in the plurality of operational phases;
wherein:
during the first operational phase, the first control unit controls the first switching module to switch to an ON-state, such that the input voltage charges the first capacitor;
during the second operational phase, the first control unit controls the second switching module to switch to the ON-state, such that charges stored in the first capacitor are transferred to the first reservoir capacitor;
during the third operational phase, the first control unit controls the first switching module to switch to the ON-state, such that the input voltage charges the first capacitor; and
during the fourth operational phase, the first control unit controls the third switching module to switch to the ON-state, such that the charges stored in the first capacitor are transferred to the second reservoir capacitor.

6. The charge pump circuit of claim 5, wherein the charge module charges the second reservoir capacitor when the charge pump unit operates in the first operational phase, the second operational phase, or the third operational phase.

7. The charge pump circuit of claim 6, wherein the charge module charges the second reservoir capacitor when the charge pump unit operates in the first operational phase, the second operational phase, and the third operational phase.

8. The charge pump circuit of claim 6, wherein the charge module comprises:
a second capacitor;
a fourth switching module, coupled to the input end, the reference voltage, and the second capacitor;
a fifth switching module, coupled to the reference voltage, the second capacitor, and the second output end; and
a second control unit, for controlling ON/OFF states of the fourth switching module and the fifth switching module, in order to control the charge module to respectively operate in a first charge unit operational phase and a second charge unit operational phase when the charge pump unit operates in the first operational phase, the second operational phase, or the third operational phase;
wherein during the first charge unit operational phase, the second control unit controls the fourth switching module to switch to the ON-state, such that the input voltage charges the second capacitor; and during the second charge unit operational phase, the second control unit controls the fifth switching module to switch to the ON-state, such that charges stored in the second capacitor are transferred to the second reservoir capacitor.

9. The charge pump circuit of claim 8, wherein a first switching frequency between the first charge unit operational phase and the second charge unit operational phase of the charge module is higher than a second switching frequency between the first operational phase, the second operational phase, the third operational phase, and the fourth operational phase of the charge pump unit.

10. The charge pump circuit of claim 8, wherein the second reservoir capacitor, the charge module, the first switching module, the second switching module, the third switching module, the second capacitor, the fourth switching module, as well as the fifth switching module are disposed in a chip; and the first reservoir capacitor as well as the first capacitor are externally connected to the chip.

11. The charge pump circuit of claim 6, wherein the charge module further charges the first reservoir capacitor when the charge pump unit operates in the first operational phase, the second operational phase, or the fourth operational phase.

12. The charge pump circuit of claim 11, wherein the charge module charges the second reservoir capacitor when the charge pump unit operates in the first operational phase, the second operational phase, and the third operational phase; and the charge module charges the first reservoir capacitor when the charge pump unit operates in the first operational phase, the second operational phase, and the fourth operational phase.

13. The charge pump circuit of claim 11, wherein the charge module comprises:
a first charge unit, comprising:
a second capacitor;
a fourth switching module, coupled to the input end, the reference voltage, and the second capacitor;
a fifth switching module, coupled to the reference voltage, the second capacitor, and the second output end; and
a second control unit, for controlling ON/OFF states of the fourth switching module and the fifth switching module, in order to control the first charge unit to respectively operate in a first charge unit operational phase and a second charge unit operational phase when the charge pump unit operates in the first operational phase, the second operational phase, or the third operational phase;
wherein during the first charge unit operational phase, the second control unit controls the fourth switching module to switch to the ON-state, such that the input voltage charges the second capacitor; and during the second charge unit operational phase, the second control unit controls the fifth switching module to switch to the ON-state, such that the charges stored in the second capacitor are transferred to the second reservoir capacitor; and
a second charge unit, comprising:
a third capacitor;
a sixth switching module, coupled to the input end, the reference voltage, and the third capacitor;
a seventh switching module, coupled to the input end, the third capacitor, and the first output end; and
a third control unit, for controlling ON/OFF states of the sixth switching module and the seventh switching module, in order to control the second charge unit to respectively operate in a third charge unit operational phase and a fourth charge unit operational phase when the charge pump unit operates in the first operational phase, the third operational phase, or the fourth operational phase;
wherein during the third charge unit operational phase, the third control unit controls the sixth switching module to switch to the ON-state, such that the input voltage charges the third capacitor; and during the fourth charge unit operational phase, the third control unit controls the seventh switching module to switch to the ON-state, such that the charges stored in the third capacitor is transferred to the first reservoir capacitor.

14. The charge pump circuit of claim 13, wherein both a switching frequency between the first charge unit operational phase and the second charge unit operational phase of the first charge unit and a switching frequency between the third charge unit operational phase and the fourth charge unit operational phase of the second charge unit are higher than a switching frequency between the first operational phase, the second operational phase, the third operational phase, and the fourth operational phase of the charge pump unit.

15. The charge pump circuit of claim 13, wherein the second reservoir capacitor, the charge module, the first switching module, the second switching module, the third switching module, the second capacitor, the fourth switching module, the fifth switching module, the third capacitor, the sixth switching module as well as the seventh switching module are disposed in a chip; and the first reservoir capacitor as well as the first capacitor are externally connected to the chip.

16. The charge pump circuit of claim 5, wherein the charge module charges the first reservoir capacitor when the charge pump unit operates in the first operational phase, the third operational phase, or the fourth operational phase.

17. The charge pump circuit of claim 16, wherein the charge module charges the first reservoir capacitor when the charge pump unit operates in the first operational phase, the third operational phase, and the fourth operational phase.

18. The charge pump circuit of claim 16, wherein the charge module comprises:
a second capacitor;
a fourth switching module, coupled to the input end, the reference voltage, and the second capacitor;
a fifth switching module, coupled to the input end, the second capacitor, and the first output end; and
a second control unit, for controlling ON/OFF states of the fourth switching module and the fifth switching module, in order to control the charge module to respectively operate in a first charge unit operational phase and a second charge unit operational phase when the charge pump unit operates in the first operational phase, the third operational phase, or the fourth operational phase;
wherein during the first charge unit operational phase, the second control unit controls the fourth switching module to switch to the ON-state, such that the input voltage charges the second capacitor; and during the second charge unit operational phase, the second control unit controls the fifth switching module to switch to the ON-state, such that charges stored in the second capacitor are transferred to the first reservoir capacitor.

19. The charge pump circuit of claim 18, wherein a first switching frequency between the first charge unit operational phase and the second charge unit operational phase of the charge module is higher than a second switching frequency between the first operational phase, the second operational phase, the third operational phase, and the fourth operational phase of the charge pump unit.

20. The charge pump circuit of claim 18, wherein the second reservoir capacitor, the charge module, the first switching module, the second switching module, the third switching module, the second capacitor, the fourth switching module, as well as the fifth switching module are disposed in a chip; and the first reservoir capacitor as well as the first capacitor are externally connected to the chip.

21. The charge pump circuit of claim 1, wherein the second reservoir capacitor as well as the charge module are disposed in a chip; and the first reservoir capacitor is externally connected to the chip.

22. A driving method applied to a charge pump circuit, which drives the charge pump circuit to output a positive pumping voltage and a negative pumping voltage according to an input voltage, the charge pump circuit comprising a charge pump unit and a charge module, and the driving method comprising the steps of:
receiving the input voltage;
making use of the charge pump unit for charging the first reservoir capacitor and the second reservoir capacitor respectively by referring to a plurality of operational phases, wherein the charge pump unit does not charge at least one designated reservoir capacitor of the first reservoir capacitor and the second reservoir capacitor during at least one designated operational phase of the plurality of operational phases;
making use of the charge module for charging the at least one designated reservoir capacitor when the charge pump unit operates in the at least one designated operational phase; and
outputting the positive pumping voltage via the first reservoir capacitor, and outputting the negative pumping voltage via the second reservoir capacitor.

23. The driving method of claim 22, wherein the at least one designated reservoir capacitor comprises the first reservoir capacitor.

24. The driving method of claim 23, wherein the at least one designated reservoir capacitor comprises the second reservoir capacitor.

25. The driving method of claim 22, wherein the at least one designated reservoir capacitor comprises the second reservoir capacitor.
